(19) United States
(12) Patent Application Publication
(10) Pub. No.: US 2007/0029935 A1
(43) Pub. Date: Feb. 8, 2007

(54) Electron emission device

(75) Inventors: Tadashi Sakai, Kanagawa (JP); Tomio Ono, Kanagawa (JP); Naoshi Sakuma, Kanagawa (JP); Hiroaki Yoshida, Kanagawa (JP); Mariko Suzuki, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/495,731

(22) Filed: Jul. 31, 2006

(30) Foreign Application Priority Data
Aug. 3, 2005 (JP) 2005-225898

(51) Int. Cl. H01J 17/02

(52) U.S. Cl. 313/609

(57) ABSTRACT

The electron emission device includes a first electrode; a semiconductor barrier that has a first face disposed to face the first electrode and a second face which is opposite face of the first face, and is formed with a wide bandgap semiconductor; an insulating material that forms a space sealed between the first electrode and the semiconductor barrier; an inert gas that is encapsulated in the space; a second electrode that is disposed to face a second face of the semiconductor barrier interposing vacuum therebetween; a first voltage applying unit that applies a voltage between the first electrode and the semiconductor barrier; and a second voltage applying unit that applies a voltage between the semiconductor barrier and the second electrode.

### CROSS-REFERENCE TO RELATED APPLICATIONS

This application is based upon and claims the benefit of priority from the prior Japanese Patent Application No. 2005-225898, filed on Aug. 3, 2005; the entire contents of which are incorporated herein by reference.

### BACKGROUND OF THE INVENTION

1. Field of the Invention

The present invention relates to an electron emission device that emits electrons into a vacuum and a technique of emitting electrons from a plane-type structure upon application of a voltage.

2. Description of the Related Art

Conventionally, vacuum electron sources that emit electrons into a vacuum have been used as components for various electronic devices. Since the vacuum electron emission sources is an essential element in various devices, there have been a number of studies and developments made for higher performances.

Principles themselves of the electron emission can be roughly divided into the following categories: a thermal electron emission, a field electron emission, and a field-thermal electron emission that falls therebetween. First, the thermal electron emission is carried out by heating a cathode to supply greater energy than the work function to the cathode. As a result, electrons are emitted. Accordingly, to emit electrons, there is no need to apply a high bias voltage between the cathode and an anode, and a low-voltage operation can be advantageously performed. Also, stable emission current can be readily maintained, as the structure is designed to emit electrons through thermal equilibrium. Here, a “cathode” is an electrode that emits electrons.

However, in case of heating, the energy for heating is required and switching on and off of discharge cannot be performed promptly, because a change in temperature requires time. Also, since thermal electrons have various energy levels, the emitted electron also exhibit various energy levels. As a result, the operations accompany indistinctness in control, which is a serious problem from a practical point of view.

Next, in an electron source of a field electron emission type, an electric field is induced at the interface of a vacuum where an electron cannot be emitted that serves as a wall having an energy difference equivalent to the value of the work function in the cathode in an equilibrium state, thereby making the barrier thinner and emitting electrons by virtue of a tunneling effect. By this method, the heating required in thermal electron emission is unnecessary, and electron emission can be instantly switched on and off by controlling the electric field.

Although the effective thickness of the barrier is normally reduced by virtue of the field concentrating effect of a sharp-pointed structure in accordance with the field emission method, the electron emission is greatly affected by changes and variations in the shape of the sharp-pointed structure. As a result, the variation in discharge characteristics becomes wider. The field emission method is employed in cases where short-term adjustments can be made. However, it is difficult to employ the field emission method in cases where stable electron emission is required over a long period of time or electron emission is greatly affected by the variation in emission current, because the discharge characteristics vary due to adhesion of ionized elements or the likes.

To counter this problem, several methods of emitting electrons through a plane-type structure using a wide bandgap semiconductor as typified by a diamond have been suggested. For example, JP-A 2001-68011 (KOKAI, hereinafter referred to as the “first reference”) discloses a technique of emitting electrons by applying a voltage to a n-type diamond. Also, US-A 2004/0084637 (hereinafter referred to as the “second reference”) discloses, in its specification, a technique of emitting secondary electrons from a diamond barrier to which primary electrons are irradiated from an emitter.

According to the description disclosed in the first reference, a voltage is applied to n-type diamond so as to emit electrons. However, there is the problem of low discharge efficiency, as the number of electrons to be emitted is small for the voltage to be applied to excite every electrons to such a degree as to cause electron emission. Therefore, it is preferable to excite electrons by a method other than voltage application.

In the description disclosed in the second reference, primary electrons are emitted onto a diamond barrier, so as to emit secondary electrons. However, it is difficult to emit primary electrons uniformly and evenly to the diamond barrier, as the primary electrons have energizes to emit secondary electrons. This is because a variation is caused in motion energy due to collisions among electrons.

### SUMMARY OF THE INVENTION

According to one aspect of the present invention, an electron emission device includes a first electrode; a semiconductor barrier that has a first face disposed to face the first electrode and a second face which is opposite face of the first face, and is formed with a wide bandgap semiconductor; an insulating material that forms a space sealed between the first electrode and the semiconductor barrier; an inert gas that is encapsulated in the space; a second electrode that is disposed to face a second face of the semiconductor barrier interposing vacuum therebetween; a first voltage applying unit that applies a voltage between the first electrode and the semiconductor barrier; and a second voltage applying unit that applies a voltage between the semiconductor barrier and the second electrode

### BRIEF DESCRIPTION OF THE DRAWINGS

FIG. 1 is a side cross-sectional view showing an electron emission device in accordance with a first embodiment;

FIG. 2 is an explanatory diagram showing an energy band of the diamond barrier and electrons excited in the diamond barrier of the electron emission device in accordance with the first embodiment;

FIG. 3 is a perspective view showing a discharge cell and an anode of the electron emission device in accordance with the first embodiment;

FIG. 4 is an explanatory diagram showing a phenomenon that is observed in the electron emission device in accordance with the first embodiment;

FIG. 5 is a side cross-sectional view showing an electron emission device in accordance with a second embodiment;

FIG. 6 is an explanatory diagram showing a course of events that take place when electrons are emitted into a vacuum using a trigger switch in the electron emission device in accordance with the second embodiment;

FIG. 7 is a side cross-sectional view showing an electron emission device in accordance with a third embodiment;

FIG. 8 is a side cross-sectional view showing an electron emission device in accordance with a fourth embodiment;

FIG. 9 is a side cross-sectional view showing an example of a power switch to which one of the electron emission devices is applied; and

FIG. 10 is a side cross-sectional view showing an example of an X-ray irradiation device to which one of the electron emission devices is applied.

### DETAILED DESCRIPTION OF THE INVENTION

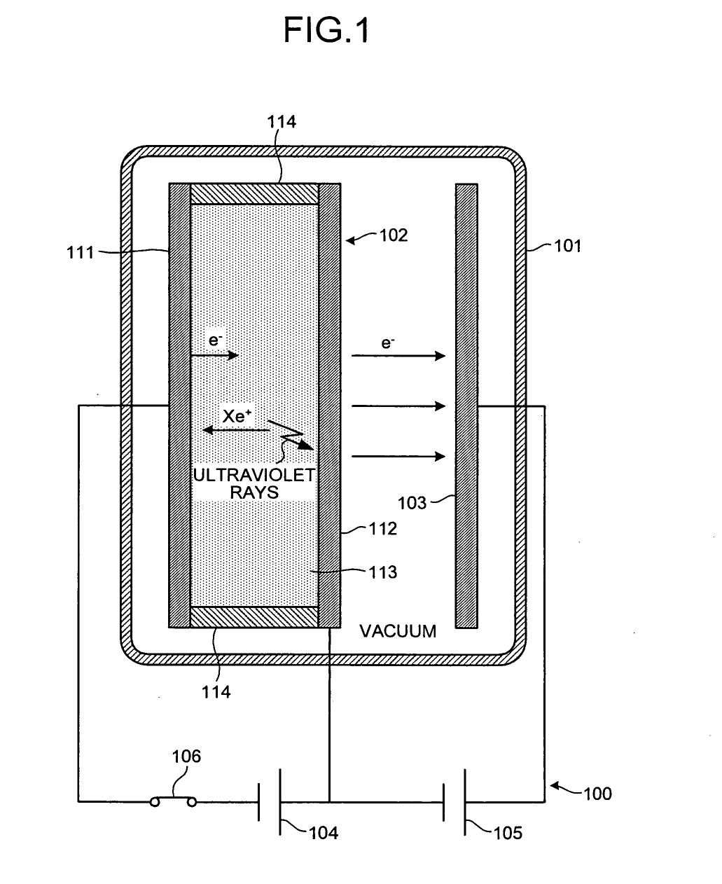

FIG. 1 is a side cross-sectional view showing an electron emission device 100 in accordance with a first embodiment of the present invention. As shown in this drawing, the electron emission device 100 has a discharge cell 102 and a discharge anode 103 provided inside an airtight container 101 to be evacuated, and also has a turn-off switch 106, a first power source 104 and a second power source 105 provided outside the airtight container 101. Since this drawing was prepared for ease of explanation, the size ratio of this draining is not necessarily the same as those in the explanation and the other drawings.

The airtight container 101 is evacuated so as to discharge electrons in a vacuum. The airtight container 101 may have any shape and size, and may be made of any kind of material, as long as it can be evacuated. In a case where a fluorescent material is applied to the discharge anode 103, for example, the discharged electrons run into the fluorescent material to generate light. In that case, the airtight container 101 may be made of a transparent material so that the generated light becomes clearly visible to eyes of a user.

The turn-off switch 106 is used for turning ON and OFF of an electron discharge. When the turn-off switch 106 is turned ON, an electron discharge is started.

The discharge cell 102 includes an in-cell cathode 111, a diamond barrier 112, and insulating spacers 114 that adjust the distance between the in-cell cathode 111 and the diamond barrier 112. An inert gas 113 is contained in the discharge cell 102. In this embodiment, xenon (Xe) is employed for the inert gas 113, for example. When the inert gas 113 is sealed in the discharge cell 102, mercury may be sealed in as well. The sealed mercury is excited when colliding with electrons or the ionized inert gas 113, so as to generate ultraviolet rays. In the entire electron emission device 100, the discharge cell 102 functions as a cathode that discharges electrons in a vacuum.

The inert gas 113 sealed in the discharge cell 102 is not limited to xenon, and may be a gas of some other element. An “inert gas” is a very stable gas that does not readily react with another element, and may include helium (He), neon (Ne), argon (Ar), krypton (Kr), xenon (Xe), radon (Rn), or the like.

The in-cell cathode 111 is a cathode connected to the cathode side of the first power source 104 as described later. With the diamond barrier 112 of the discharge cell 102 serving as an anode, the first power source 104 is turned on to cause discharge with the inert gas 113 sealed in the discharge cell 102. The ultraviolet rays generated by this discharge are emitted onto the diamond barrier 112. As a result, Xe⁺ generated by the discharge is attracted to the in-cell cathode 111, and the in-cell cathode 111 transfers electrons to Xe⁺ on its surface. The ultraviolet rays generated by the discharge have utterly uniform wavelengths.

The diamond barrier 112 has a first face that faces the in-cell cathode 111, and a second face that faces the discharge anode 103. The second face of the diamond barrier 112 is hydrogen-terminated in advance, so that the electron affinity can be reduced. It is more preferable to reduce the electron affinity to a negative value by the hydrogen termination. Here, the hydrogen termination is carried out by subjecting the diamond barrier 112 to hydrogen plasma.

Since the diamond barrier 112 is in contact with the inert gas 113, which is sealed between the diamond barrier 112 and the in-cell cathode 111, on the first face, the ultraviolet rays generated by the discharge in the inert gas are emitted onto the first face.

In this embodiment, the material for the diamond barrier 112 is not limited to diamond, as long as it is a wide bandgap semiconductor. A “wide bandgap semiconductor” is a semiconductor material with a wide bandgap, such as gallium nitride, boron nitride, silicon carbide (SiC), or diamond. In this embodiment, diamond is employed.

As diamond is used in this embodiment, the bandgap is as high as 5.5 eV, thereby facilitating electron emission. Among the presently-known materials, diamond—has the highest hardness. With diamond, the thickness of each barrier that needs to be tolerant of the pressure difference between the sealed inert gas 113 and the vacuum can be made smaller than any other material. Thus, the photoexcited electrons can be prevented from being recombined inside the barrier and hindering emission. In other words, a thin barrier can increase the amount of electrons to be emitted.

The spacers 114 adjust the distance between the in-cell cathode 111 and the diamond barrier 112, and also serve to contain the inert gas 113 in the space between the in-cell cathode 111 and the diamond barrier 112. Since the spacers 114 have insulation properties, current does not flow between the in-cell cathode 111 and the diamond barrier 112.

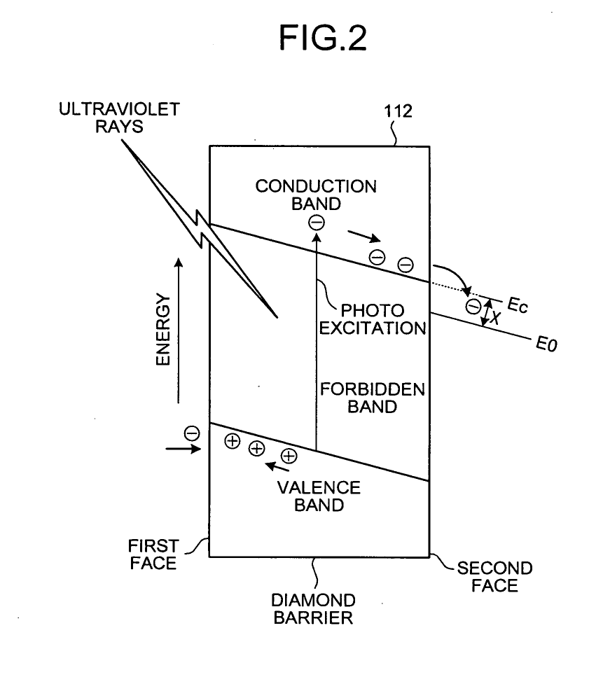

FIG. 2 is an explanatory diagram showing an energy band of the diamond barrier 112 and electrons excited inside the diamond barrier 112. In this drawing, an energy of a conduction band is represented by E_{c}, and a vacuum level is represented by Eₒ. The difference between the vacuum level Eₒ and the energy of the conduction band E_{c} is defined as an electron affinity X. Where the diamond barrier 112 that has a wide bandgap and is hydrogen-terminated is used as in this embodiment, the electron affinity X exhibits a negative value. When the electron affinity X is a negative value, there are no barriers between the diamond barrier 112 and the vacuum.

With the diamond barrier 112 serving as an anode, discharge is caused in the discharge cell 102, so as to generate ultraviolet rays in the vacuum ultraviolet region. The rays in the vacuum ultraviolet region have an energy that can exceed the bandgap in the diamond barrier 112. Therefore, when the ultraviolet rays are emitted onto the diamond barrier 112, the electrons in the valence band are excited to the conduction band beyond the bandgap. In this manner, pairs of free electrons and holes are generated in the diamond barrier 112.

First, the holes in the diamond barrier 112 are drawn to the first face of the diamond barrier 112 by virtue of the electric field between the diamond barrier 112 and the in-cell cathode 111 in the discharge cell 102. The xenon ions that are ionized by the discharge in the discharge cell 102 and have positive charges are then drawn to the in-cell cathode 111 (not shown). The electrons that are ionized by the discharge are drawn to the diamond barrier 112. As a result, the holes and electrons are combined and neutralized in the barrier.

Meanwhile, the photoexcited free electros move toward the second face of the diamond barrier 112 by virtue of the electric field induced between the diamond barrier 112 and the discharge anode 103 that is disposed with the vacuum interposed between the diamond barrier 112 and the discharge anode 103. With the negative electron affinity of the diamond having its surface hydrogen-terminated, there are no barriers formed between the diamond barrier 112 and the vacuum. Accordingly, the electrons can be emitted into the vacuum through the surface of the second face with high efficiency.

Through this process, electrons and holes are continuously excited by light, while the inside of the diamond barrier 112 is not charged. The electrons are then emitted from the second face located on the vacuum side of the diamond barrier 112. In this manner, the diamond barrier 112 serves as an anode to cause discharge while storing high-energy electrons inside by virtue of the light generated by the discharge in the vacuum ultraviolet region.

The electrons are then emitted into the vacuum with a low electric field by virtue of the negative electron affinity of diamond. In contrast, since electrons that are generated by the discharge caused with the positively charged diamond barrier 112 that serves as an anode and does not maintain the charge neutrality due to the electron emission are supplied, holes can be neutralized. In this manner, vacuum electron emission with a low electric field and a large area can be continuously achieved.

Since the ultraviolet rays emitted onto the diamond barrier 112 have utterly uniform wavelengths in the vacuum ultraviolet region generated by the discharge, the excitation energy used for photoexciting the electrons inside the barrier becomes uniform. Thus, the energy of the photoexcited electrons can exhibit uniformity.

Referring back to FIG. 1, the discharge anode 103 is disposed to face the second face of the diamond barrier 112 of the discharge cell 102 in the vacuum formed by the airtight container 101. The electrons emitted through the diamond barrier 112 of the discharge cell 102 collide with the discharge anode 103. The electrons emitted into the vacuum maintain the current in the vacuum.

The first power source 104 applies a voltage between the in-cell cathode 111 and the diamond barrier 112, with the diamond barrier 112 serving as an anode side. The first power source 104 corresponds to the first voltage applying unit. In this manner, the first power source 104 applies a voltage to the discharge cell 102, thereby starting discharge.

The second power source 105 applies a voltage between the diamond barrier 112 and the discharge anode 103, with the discharge anode 103 serving as an anode side. The second power source 105 corresponds to the second voltage applying unit. By virtue of the electric field induced by the voltage application, electrons are emitted through the diamond barrier 112, and collide with the discharge anode 103.

In the first power sourse 104 and the second power source 105, the anode side of the first power source 104 and the cathode side of the second power source 105 are connected with a wire. The first power source 104 and the second power source 105 are connected to the diamond barrier 112 with a shared electric path. With this arrangement, after electrons are emitted into the vacuum, a power source circuit that has the first power source 104 and the second power source 105 which are wire-connected in series is formed.

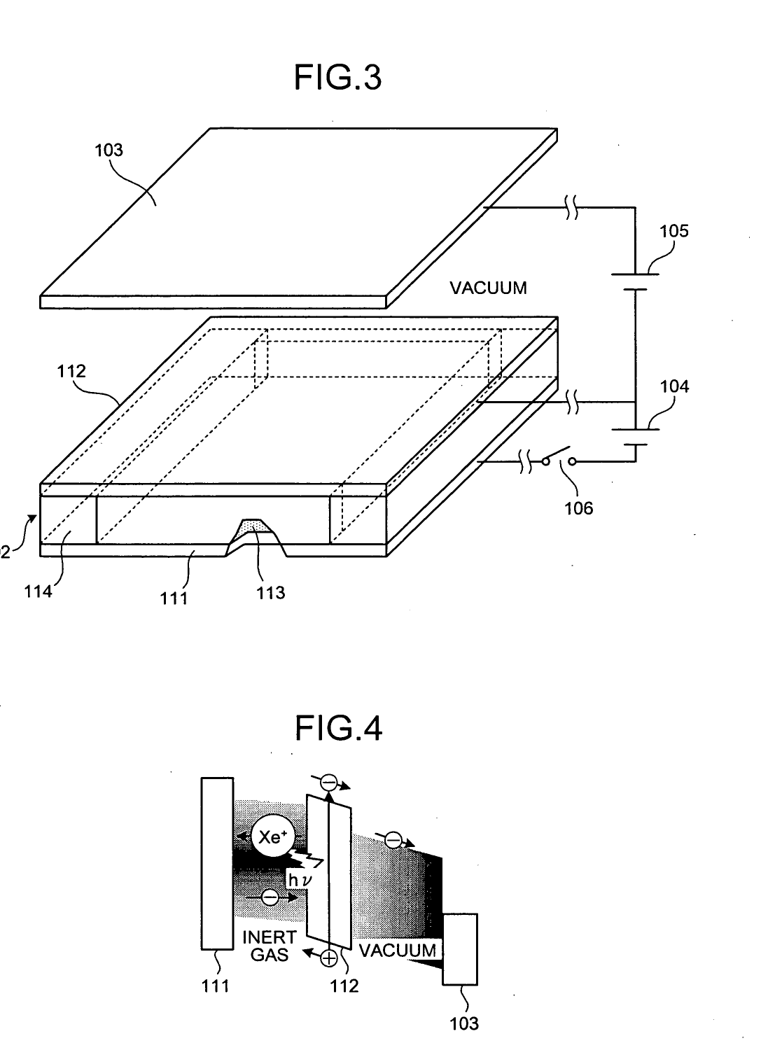

FIG. 3 is a perspective view showing the discharge cell 102 and the discharge anode 103 of this embodiment. As shown in this drawing, the discharge anode 103 and the discharge cell 102 are disposed to face each other. The discharge cell 102 is formed by bonding the spacers 114 to the four sides of the diamond barrier 112, and the in-cell cathode 111 is then attached air-tightly to the spacers 114 in the inert gas 113. Accordingly, the inert gas 113 is encapsulated in the space between the diamond barrier 112 and the in-cell cathode 111. With this arrangement, the inert gas 113 encapsulated in the discharge cell 102 is prevented from leaking into the vacuum.

FIG. 4 is an explanatory diagram showing the phenomenon observed in the electron emission device 100 of this embodiment. As shown in FIG. 4, the electron energy is higher as it is measured in a higher position. As can be seen from this drawing, ultraviolet rays are generated by the discharge caused between the in-cell cathode 111 and the diamond barrier 112, and the electrons generated by the discharge are drawn to the diamond barrier 112. Further, the ionized xenon (Xe) is drawn to the in-cell cathode 111. The ionized xenon is combined with the electrons existing on the surface of the in-cell cathode 111. As the ultraviolet rays are emitted, electrons and holes are excited in the diamond barrier 112, and the holes existing on the first face of the diamond barrier 112 are combined with the electrons existing in the discharge plasma. Meanwhile, the electrons excited in the diamond barrier 112 move toward the second face of the diamond barrier 112, as an electric field is induced from the discharge anode 103 disposed at a distance from the diamond barrier 112, with the vacuum being interposed therebetween. Since there are no barriers by virtue of the negative electron affinity, the electrons can be readily emitted into the vacuum. The emitted electrons move toward the discharge anode 103 and collide with the discharge anode 103.

Although the electron affinity is negative in this embodiment, electrons can be readily emitted even if the electron affinity is positive, as long as it exhibits a low value. Accordingly, electrons can be readily emitted, without performing a terminating process such as hydrogen termination. Also, a wide bandgap semiconductor other than diamond may be employed for the barrier, as long as it has a wide bandgap and a low or negative electron affinity. With such a wide bandgap semiconductor, electrons can be readily emitted.

The electron emission device 100 of this embodiment achieves uniform electron energy while showing stable electron emission characteristics. In short, the electron emission device 100 has both of advantages in the stable electron emission characteristics of the existing thermal cathode type and in the uniformity of the electron energy in the cold cathode type. This is because the excitation energy becomes uniform when excitation is caused by the emission of ultraviolet rays, as described above.

Also, electron emission from a plane electron emission that has been difficult due to its high electron affinity can be achieved with a low voltage. Accordingly, electrons can be readily emitted by virtue of the low electron affinity of a surface, without depending on a sharp-pointed structure for concentrating electric fields as in the conventional cold cathode type. Also, since the specific strength of the diamond barrier 112 is high as described above, the diamond barrier 112 can be made thin, and loss of electrons to be emitted into the vacuum can be restrained. Thus, the stability of the current flowing in the vacuum can be increased.

Although the low electron affinity of a diamond surface is already known, electron supply is essential to be used as an actual cathode for vacuum electron emission. Therefore, it is necessary to have both the low electron affinity on the surface and the n-type characteristics. However, even if the electron affinity on the surface of the barrier is made negative, upward band bending is caused in the n-type structure. When seen from the bulk region, there is substantially a barrier between the electron energy levels in the vacuum. To counter this problem, a p-type material is used for the diamond barrier 112 in the electron emission device 100 of this embodiment: Even with the p-type material, the electron energy holds higher than the vacuum level when electrons are excited. Accordingly, the surface is hydrogen-terminated so that the electron affinity becomes negative. Thus, electrons can be readily emitted. In short, the electron emission device 100 of this embodiment enables to have high electron emission.

It is noted that the present embodiment does not limit the material for the barrier to p-type diamond in the electron emission device. Even where n-type diamond is used as the barrier, the electron affinity becomes negative. Accordingly, electron emission into a vacuum is easier than in a case where some other material is employed. Thus, n-type diamond may also be used as the barrier.

As described above, electron emission is performed by virtue of the negative or very low electron affinity, while the electron charge supply to the conductor, which has been a defect with a conductor as an electron emission source, is carried out by generating pairs of electrons and holes through photoexcitation. The generation of ultraviolet rays for causing the photoexcitation and the neutralization of the holes generated at the time of the photoexcitation can be carried out simultaneously through the discharge caused in the inert gas 113 inside the diamond barrier 112.

Furthermore, since diamond has the highest hardness among all materials, the barrier of the discharge cell 102 can be formed with an extremely thin diaphragm. Accordingly, the number of electrons that cannot be emitted to the outside due to recombination within the barrier can be minimized when the pairs of electrons and holes generated through photoexcitation move in the thickness direction inside the barrier.

The electron emission device 100 of the first embodiment does not perform control in particular when electrons are emitted after the power source circuit is energized by the turn-off switch 106. However, the present invention is not limited to such a structure, but may have a structure for starting highly-efficient electron emission and perform control with the structure when electrons are emitted. Therefore, a second embodiment of the present invention is a structure that is equipped with a trigger switch that controls switching on and off the current in the circuit.

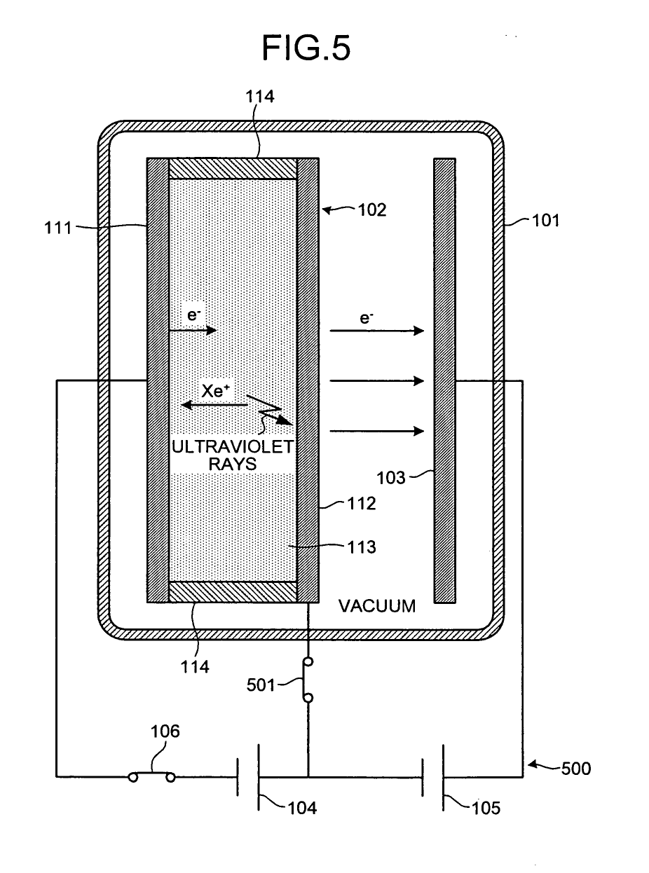

FIG. 5 is a side cross-sectional view showing an electron emission device 500 in accordance with the second embodiment. The electron emission device 500 differs from the electron emission device 100 of the first embodiment in further including a trigger switch 501. In the following description, the same components as those of the first embodiment are denoted by the same reference numerals as those of the first embodiment, and explanation of them is omitted.

The trigger switch 501 is disposed on the shared electric path connecting the first power source 104 and the second power source 105 to the diamond barrier 112, and switches on and off current.

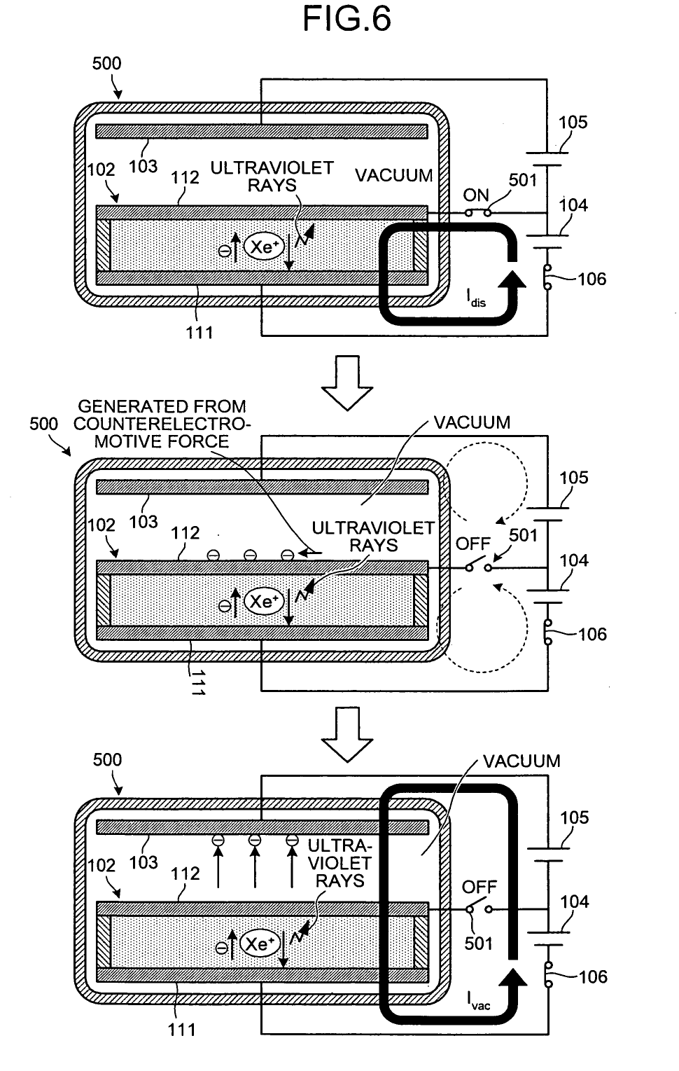

FIG. 6 is an explanatory diagram showing a course of events that take place when electrons are emitted into the vacuum using the trigger switch 501 in the electron emission device 500 of this embodiment. As shown in the drawing on the top in FIG. 6, when the turn-off switch 106 performs energization to start an operation while the trigger switch 501 is in an ON state, the first power source 104 applies a voltage to the discharge cell 102. Accordingly, discharge is caused in the discharge cell 102, and a current Idis is formed.

As shown in the middle drawing in FIG. 6, when a control is performed to turn off the trigger switch 501, the current I_{dis} flowing in the circuits of the first power source 104 and the discharge cell 102 starts decreasing, and the counterelectromotive force to stop the decrease in current is generated at either end of the trigger switch 501. As a result, the potential of the discharge anode 103 becomes higher and electrons move to the second face of the diamond barrier 112 .

As shown in the bottom drawing in FIG. 6, electrons are then emitted into the vacuum toward the discharge anode 103 through the second face of the diamond barrier 112. Those emitted electrons form a current I_{vac} that is maintained in the circuit in which the first power source 104 and the second power source 105 are connected in series. The electrons that reach the discharge anode 103 form a circuit that extends from the in-cell cathode 111 in the discharge cell 102 via the discharge anode 103 by virtue of the current flowing through the vacuum, and connects the first power source 104 and the second power source 105 in series. With this structure, current flows from the diamond barrier 112 via the discharge anode 103 even when the trigger switch 501 is in an OFF state. In this embodiment, a reactive current is not caused, as the current in the discharge cell 102 does not decrease but turns into the current flowing between the diamond barrier 112 and the discharge anode 103.

The above described electron emission device of this embodiment can only control the switching on and off of electron emission by the turn-off switch 106, so as to adjust the amount of electrons to be emitted. However, the present invention is not limited to such a control operation, and a mechanism for controlling the amount of current or the amount of electrons to be emitted may be employed. Therefore, a structure that further includes a variable resistor so as to control the amount of electrons to be emitted is provided as a third embodiment.

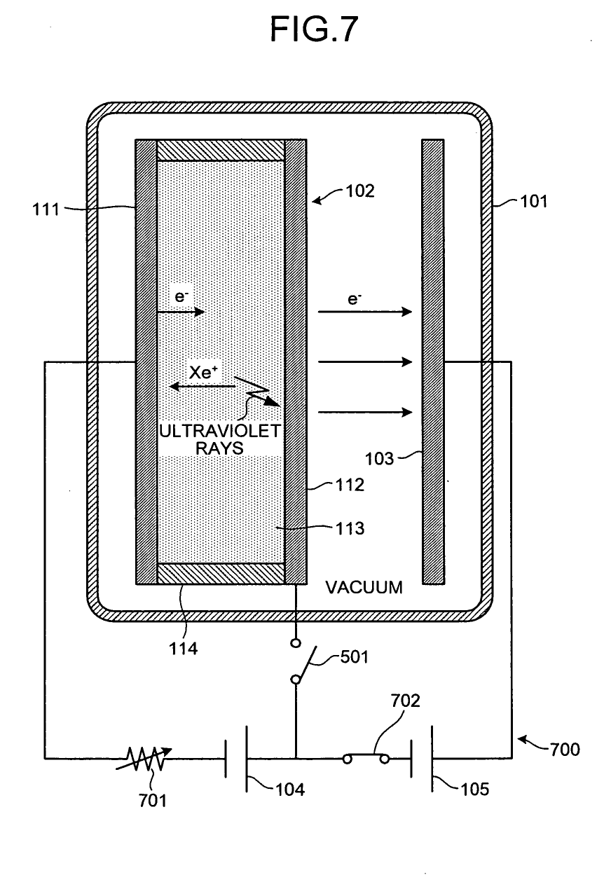

FIG. 7 is a side cross-sectional view showing an electron emission device 700 in accordance with a third embodiment. The electron emission device 700 differs from the electron emission device 500 of the second embodiment in further including a variable resistor 701 and having a turn-off switch 702 located in a different position from the turn-off switch 106. In the following description, the same components as those of the first and second embodiments are denoted by the same reference numerals as those of the first and second embodiments, and explanation of them is omitted.

The turn-off switch 702 is used for switching on and off electron emission, and differs from the turn-off switch 106 only in location. The turn-off switch 702 is switched off, so that the current flowing after electrons are emitted into the vacuum can be cut off. Accordingly, a turn-off switch may be located-in any position, as electron emission can be switched on and off as long as the turn-off switch is located in the path through which the current flows after electrons are emitted into the vacuum.

The variable resistor 701 is a resistor that can change its resistance within a predetermined range and is located in the electric path connecting the discharge cell 102 to the cathode side of the first power source 104. The resistance of the variable resistor 701 is varied to change the voltage to be applied between the discharge cell 102 and the discharge anode 103. Accordingly, emission current or the amount of electrons to be emitted can be changed. The variable resistor 701 changes the current generated by varying the voltage to be applied, and therefore, is equivalent to the current changing unit.

In the electron emission device 700 of the third embodiment, the variable resistor 701 is disposed in the electric path connecting the discharge cell 102 to the cathode side of the first power source 104. However, the variable resistor 701 may be placed in any position, as long as the amount of current can be adjusted by varying the voltage to be applied. Therefore, an electron emission device in accordance with a fourth embodiment of the present invention is a structure in which a variable resistor is placed in a shared electric path connecting the first power source 104 and the second power source 105 to the diamond barrier 112.

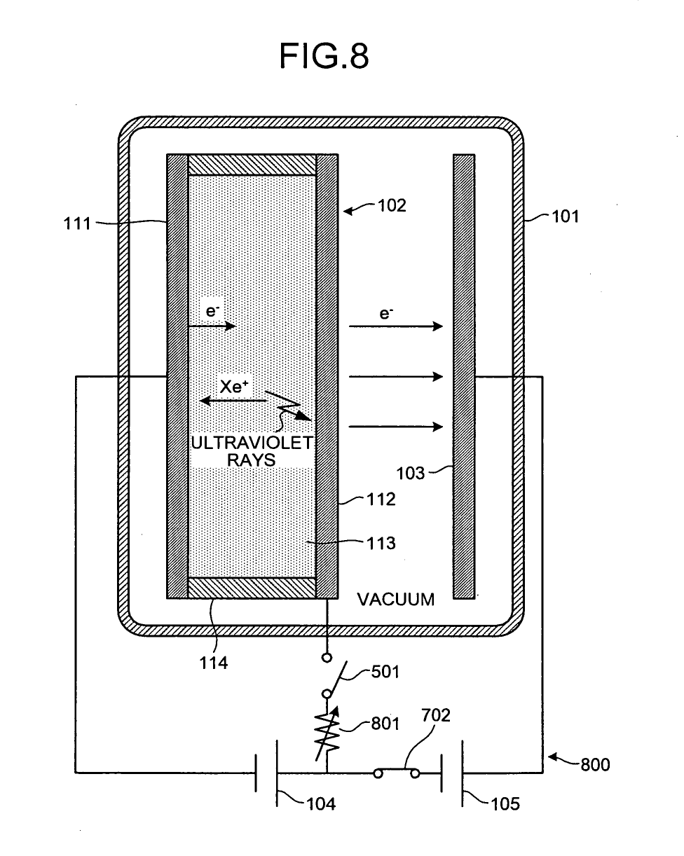

FIG. 8 is a side cross-sectional view showing an electron emission device 800 in accordance with the fourth embodiment. The electron emission device 800 differs from the electron emission device 700 of the third embodiment in that a variable resistor 801 is disposed in a different position from the variable resistor 701. In the following description, the same components as those of the third embodiment are denoted by the same reference numerals as those of the third embodiment, and explanation of them is omitted.

Like the variable resistor 701 of the third embodiment, the variable resistor 801 is a resistor that can vary its resistance within a predetermined range and is disposed in the shared electric path connecting the first power source 104 and the second power source 105 to the diamond barrier 112.

Since the voltage to be applied between the discharge cell 102 and the first power source 104 can be varied by the variable resistor 801, the current that bypasses from the diamond barrier 112 without passing through the dischage anode 103 can be adjusted. Accordingly, the resistance is varied by the variable resistor 801 while the trigger switch 501 is in an ON state, so that the voltage to be applied can be changed. Although reactive current is generated, the amount of current generated by electron emission can be readily controlled.

The variable resistor 801 may be disposed in any other position. Other than the positions described in the third and fourth embodiments, the electric path connecting the first power source 104 to the second power source 105 or the electric path connecting the second power source 105 to the discharge anode 103 may be the position in which the variable resistor 801 is disposed.

Although only one of the variable resistor 801 is provided in the above described position in this embodiment, the number of variable resistors to be provided is not limited to one. For example, variable resistors may be provided both in the position of the variable resistor 701 of the third embodiment and in the position of the variable resistor 801 of the fourth embodiment. In this manner, more than one variable resistor may be provided in the above described electric paths.

The present invention is not limited to the above described embodiments, but various changes as follows may be made to them.

In the above described embodiments, the diamond barrier 112 employed in the discharge cell 102 of each electron emission device is hydrogen—terminated to make an electron affinity negative. However, the surface of the diamond barrier 112 is not limited to be hydrogen-terminated. In a first modification, a diamond barrier is immersed in a sulfuric acid-hydrogen peroxide solution, so as to perform acid termination. As a result of an experiment, where a diamond barrier that is acid-terminated with a hydrogen peroxide solution is employed, the electron affinity of the diamond barrier becomes negative as in the case where the diamond barrier is hydrogen-terminated. Accordingly, with an electron emission device of this modification, electrons can be readily emitted into a vacuum.

Although acid termination is carried out with a hydrogen peroxide solution in this modification, it is also possible to carry out acid termination with a solution other than a hydrogen peroxide solution.

The material for the cell-in cathode 111 of each of the electron emission devices in accordance with the above described embodiments may be any material whether or not it is a known one, and therefore, explanation of the material for the cell-in cathode 111 is omitted herein. However, a particular material for performing high discharge may be used to form the in-cell cathode 111. Therefore, in a second modification, conductive diamond is employed as the material for the in-cell cathode 111. The other aspects of the structure of the second modification are the same as those of the other embodiments, and therefore, explanation of them is omitted.

The in-cell cathode 111 is made of conductive diamond on the anode side of the discharge cell 102, and is connected to the first power source 104. When the first power source 104 applies a voltage to the in-cell cathode 111, electrons in the in-cell cathode 111 are excited, and are emitted in the discharge cell 102. The emitted electrons repeat collisions so as to generate ultraviolet rays. Also, as the in-cell cathode 111 is made of conductive diamond, the electron affinity is very low or negative, and a larger number of electrons are emitted than in a case where some other material is employed for the in-cell cathode 111. In short, with the use of conductive diamond, the quantity of ultraviolet rays is larger than in a case where some other material is employed. With the larger quantity of ultraviolet rays, the amount of electrons to be excited can be increased, and the amount of electrons to be emitted into the vacuum can also be increased accordingly. Thus, higher output can be achieved.

Furthermore, since diamond has a high specific strength, the in-cell cathode 111 of the discharge cell 102 can be made thinner while being resistant to high pressure.

As described above, each electron emission device of the present invention can be used as an electron source for emitting electrons into a vacuum. Particularly, a plane-type structure has a longer operating life and is suitable for applications where electron emission needs to be caused with a low voltage. Examples for applications of the present invention include a power switch for controlling the flow of electrons in a vacuum and an X-ray irradiation device that are described in the following.

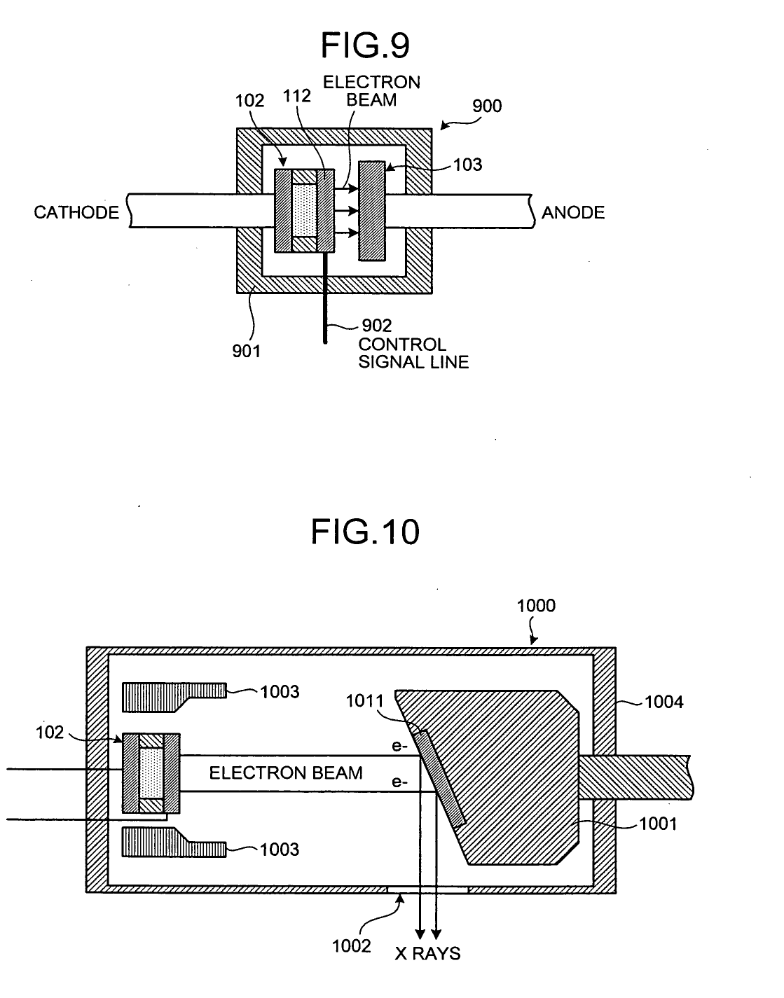

FIG. 9 is a side cross-sectional view showing a power switch 900 in which one of the above described electron emission devices is employed. As shown in FIG. 9, the discharge cell 102 and the discharge anode 103 are provided in a housing 901 that serves as an airtight container. The current flowing from the anode to the cathode is controlled by the power switch 900. Therefore, the voltage to be applied is controlled by a control signal line 902 connected to the diamond barrier 112 of the discharge cell 102. Through the control, the flow of electrons emitted into the vacuum can be switched on and off. In this manner, an electron emission device of the present invention can be used as an electron source for a power switch. The above described power switch 900 that controls the flow of electrons in a vacuum can be used for a diode, a three-terminal switch, or the like.

FIG. 10 is a side cross-sectional view showing an example of an X-ray irradiation device 1000 in which one of the above described electron emission devices is employed. As shown in FIG. 10, the X-ray irradiation device 1000 includes a convergence tube 1003, a discharge cell 102, a target 1011, and a discharge anode 1001 that are all provided in a tube housing 1004 that serves as an airtight container. The tube housing 1004 has a radiation window 1002. The discharge cell 102 is provided inside the convergence tube 1003. The target 1011 is made of a metal such as tungsten or copper.

Electrons emitted from the discharge cell 102 into a vacuum are accelerated by virtue of an electric field induced by the discharge anode 1001 and collide against the target 1011. Through the collision, X-rays are generated. The X-rays are radiated from the tube housing 1004 through the radiation window 1002. In industrial use, a structure in which the target 1011 is disposed between the discharge cell 102 and the discharge anode 1001 may also be employed.

As described above, high-density electrons with uniform energy can be radiated from the discharge cell 102. As such electrons are focused onto the target 1011 with high precision, the X-ray irradiation device 1000 can radiate X-rays with high luminance. In this manner, an electron emission device of the present invention can also be used as an electron source for an X-ray irradiation device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electron emission device comprising:
a first electrode;
a semiconductor barrier that has a first face disposed to face the first electrode and a second face which is opposite face of the first face, and is formed with a wide bandgap semiconductor;
an insulating material that forms a space sealed between the first electrode and the semiconductor barrier;
an inert gas that is encapsulated in the space;
a second electrode that is disposed to face a second face of the semiconductor barrier interposing vacuum therebetween;
a first voltage applying unit that applies a voltage between the first electrode and the semiconductor barrier; and
a second voltage applying unit that applies a voltage between the semiconductor barrier and the second electrode.

2. The device according to claim 1, wherein the semiconductor barrier is made of diamond.

3. The device according to claim 1, wherein the semiconductor barrier is made of p-type diamond.

4. The device according to claim 2, wherein the second face of the diamond of the semiconductor barrier is hydrongen-terminated.

5. The device according to claim 2, wherein the second face of the diamond of the semiconductor barrier is acid-terminated.

6. The device according to claim 1, wherein:
an anode side of the first voltage applying unit and a cathode side of the second voltage applying unit are connected with a wire;
the first voltage applying unit and the second voltage applying unit are connected to the semiconductor barrier via a shared electric path; and
the electron emission device further comprises an energization switching control unit that switches between an energization and a shutdown and is provided in the shared electric path.

7. The device according to claim 1, wherein:
an anode side of the first voltage applying unit and a cathode side of the second voltage applying unit are connected with a wire;
the first voltage applying unit and the second voltage applying unit are connected to the semiconductor barrier with a shared electric path; and
the electron emission device further comprises:
a first energization switching control unit that switches between an energization and a shutdown and is provided in the shared electric path; and
a second energization switching control unit that switches between an energization and a shutdown and is provided in an arbitrary electric path among an electric path connecting the first electrode and the first voltage applying unit, an electric path connecting the first voltage applying unit and the second voltage applying unit in series, and an electric path connecting the second voltage applying unit and the second electrode.

8. The device according to claim 7, further comprising:
at least one of current variation control unit that changes an amount of current and is provided in an arbitrary one or more of an electric path among the shared electric path, the electric path connecting the first electrode and the first voltage applying unit, the electric path connecting the first voltage applying unit and the second voltage applying unit in series, and the electric path connecting the second voltage applying unit and the second electrode.

9. The device according to claim 8, wherein the current variation control unit is a variable resistor.

10. The device according to claim 1, wherein:
an anode side of the first voltage applying unit and a cathode side of the second voltage applying unit are connected with a wire;
the first voltage applying unit and the second voltage applying unit are connected to the semiconductor barrier via a shared electric path; and
the electron emission device further comprises:
at least one of current variation control unit that changes an amount of current and is provided in an arbitrary one or more of an electric path among the shared electric path, an electric path connecting the first electrode and the first voltage applying unit, an electric path connecting the first voltage applying unit and the second voltage applying unit in series, and an electric path connecting the second voltage applying unit and the second electrode.

11. The device according to claim 10, wherein the current variation control unit is a variable resistor.

12. The device according to claim 1, wherein:
an anode side of the first voltage applying unit and a cathode side of the second voltage applying unit are connected with a wire;
the first voltage applying unit and the second voltage applying unit are connected to the semiconductor barrier via a shared electric path; and
the electron emission device further comprises:
an energization switching control unit that switches between an energization and a shutdown and is provided in the shared electric path; and
at least one of a current variation control unit that changes an amount of current and is provided in an arbitrary one or more of an electric path among the shared electric path, an electric path connecting the first electrode and the first voltage applying unit, an electric path connecting the first voltage applying unit and the second voltage applying unit in series, and an electric path connecting the second voltage applying unit and the second electrode.

13. The device according to claim 12, wherein the current variation control unit is a variable resistor.

14. The device according to claim 1, wherein the first electrode is made of diamond.

15. The device according to claim 1, wherein the inert gas includes xenon.

16. The device according to claim 1, further comprising mercury that is encapsulated in the space formed by the first electrode, the semiconductor barrier and the insulating material.
